(19) United States
(12) Patent Application Publication
(10) Pub. No.: US 2026/0069900 A1
(43) Pub. Date: Mar. 12, 2026

(54) RESPIRATOR FIT TESTER

(71) Applicant: OHD, LLLP, Hoover, AL (US)

(72) Inventor: Tim Gordon, Boulder, CO (US)

(73) Assignee: OHD, LLLP, Hoover, AL (US)

(21) Appl. No.: 19/325,700

(22) Filed: Sep. 11, 2025

Related U.S. Application Data
(60) Provisional application No. 63/693,451, filed on Sep. 11, 2024.

(51) Int. Cl. A62B 27/00; G01N 15/06; G01N 15/075

(52) U.S. Cl. CPC A62B 27/00; G01N 15/065; G01N 15/075

(57) ABSTRACT

Improved respirator fit test devices including piezoelectric pumps that reduce noise and vibration of the device. The devices may include two or more piezoelectric pumps, wherein a first pump moves sheath air through a differential mobility analyzer and a second pump alternately moves aerosol from inside or outside a respirator through the differential mobility analyzer. A size selected portion of each aerosol sample is then moved through a condensation nuclei counter. Control circuitry enables user selection of a respirator type to be tested, wherein the differential mobility analyzer may be enabled or disabled based on the user selection. The control circuitry further enables calculation of a fit factor corresponding to a quantitative effectiveness of the respirator fitting a user based on signals from the condensation nuclei counter for each aerosol sample.

### CROSS-REFERENCE TO RELATED APPLICATIONS

This application claims priority to U.S. Provisional Patent Application Ser. No. 63/693,451, filed Sep. 11, 2024, the entire content of which is incorporated herein.

### FIELD OF THE INVENTION

The present disclosure generally relates to devices for respirator fit testing.

### BACKGROUND OF THE INVENTION

The use of respirators is required by several national and international standards, including the Occupational Safety and Health Administration (OSHA) in the United States, when hazardous substances in the air cannot be controlled to an acceptable level for the health of employees. As a result, millions of individuals who may encounter inhalation hazards on the job rely on respirators.

According to OSHA, to ensure a respirator provides an appropriate level of protection, it is necessary that employers develop and maintain a respiratory protection program, of which respirator fit testing is a key component. A respirator fit test evaluates the fit of a respirator to a wearer. A respirator fit test may ensure a respirator wearer is using an appropriate model, style, and size respirator. Fit testing may be performed qualitatively using a test agent detectable by the wearer, such as via the wearer's sense of taste, smell, or reaction to an irritant. Fit testing may also be performed quantitatively using an instrument to create a slight negative pressure within a mask and measure the amount of air needed to maintain the negative pressure, i.e., the controlled negative pressure method (CNP), or an instrument that measures the concentration of aerosol particles inside and outside the mask to measure leakage of ambient aerosol outside the mask, i.e., condensation nuclei counter method (CNC).

Properly fitting respirators are necessary to prevent the inhalation of contaminants. Conventional respirator fit testers are bulky, noisy, and may provide less accurate results due to pressure fluctuations within the tester, such as those caused by the pumps used to circulate the sheath air and/or the aerosol flow from inside and outside the mask through a condensation nuclei counter. As example, and with reference to FIG. 1, a prior art tester that uses the CNC method includes two flow dampeners (sheath dampeners) that are designed to reduce pressure fluctuations that lead to pulsation in the sheath air. Furthermore, pulsations in the aerosol flow are also dampened through a restriction/expansion chamber, as indicated in FIG. 1. The dampener used for the sheath air flow includes two separate chambers—one for the positive pressure side of the pump and one for the negative pressure side. Each chamber includes a rubber membrane that acts to absorb the pressure fluctuations caused by the sheath pump. In use, the sheath air pump pulls the sheath air through a filter to a negative pressure chamber and into a positive pressure chamber. Pulsation of the aerosol flow is also dampened using two additional filters. As such, inclusion of the flow dampeners not only increases the overall size and weight of the prior art respirator testers but also means that additional consumable parts are included in the tester (e.g., rubber membranes, filters, tubing).

Current discussion regarding improvements to respirator fit testers indicates that flow dampeners are still considered the best solution to the problem of flow pulsation. For example, a recent journal article indicates that the AccuFIT™ respirator tester has addressed the issue of flow pulsation through use, in part, of improved flow dampeners (Annals of Work Exposures and Health, 2021, V.65:458-462).

### SUMMARY OF THE INVENTION

The systems and methods of the present disclosure address many of the shortcomings of current respirator fit testers by including advanced pump technology and improved software that allows for a reduction in the number of required components, reduced pressure fluctuations, and/or a reduction in the noise output of the system.

Accordingly, the present disclosure relates to a respirator fit tester (“tester”). The tester generally includes a first piezoelectric pump, a second piezoelectric pump, a differential mobility analyzer, and a condensation nuclei counter. The first piezoelectric pump may be configured to circulate sheath air through the differential mobility analyzer at a constant sheath air flow rate. In some configurations, the first piezoelectric pump comprises two or more individual piezoelectric pumps positioned in parallel. The second piezoelectric pump may be configured to alternately circulate an aerosol from either inside the mask of a respirator or outside the mask of the respirator to the differential mobility analyzer at a constant aerosol flow rate and circulate a size selected portion of the aerosol from the differential mobility analyzer to the condensation nuclei counter.

According to certain aspects, the tester may be absent a flow dampener. Further, the ratio of the aerosol flow rate to the sheath air flow rate may be between 0.2 to 0.5, such as 0.3 to 0.5, or 0.4 to 0.5.

According to certain aspects, the tester may comprise a control unit having a memory and a processor in electronic communication with the condensation nuclei counter and configured to receive signals therefrom. The signals may include a sample signal indicative of the particles counted in the size selected portion of the aerosol from inside the mask of the respirator and a control signal indicative of the size selected portion of the aerosol from outside the mask of the respirator and generate an output corresponding to a ratio of the control signal to the sample signal.

According to certain aspects, the tester may comprise a switching valve configured to facilitate the alternating sampling of the aerosol from either inside the mask of the respirator or outside the mask of the respirator. The control unit may actuate the switching valve.

According to certain aspects, the tester may be part of a system that includes a server having a server memory and a server processor, wherein the server memory stores computer-readable instructions that, when executed by the processor, cause the processor to query a user of the tester about a respirator type and, based on user input of the respirator type, enable or disable the differential mobility analyzer. For example, if the respirator type is a non-sealing mask (e.g., a N95 respirator), the differential mobility analyzer is enabled, and if the respirator type is a sealing mask (elastomeric half-or full-facepiece respirator), the differential mobility analyzer is disabled. The computer-readable instructions may further cause the processor to configure the respirator and disclosed tester for a fit test and instruct the user on performing the fit test.

Additional components may be included, such as power supply(s), conduits to provide fluid communication amongst the various components and the respirator that is being tested, control units for each of the components, and filters positioned inline on various portions of the conduit.

### DESCRIPTION OF THE DRAWINGS

It is to be understood that both the foregoing summary and the following drawings and detailed description may be exemplary and may not be restrictive of the aspects of the present disclosure as claimed. Certain details may be set forth to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention. The present disclosure may be better understood by reference to the accompanying drawing sheets, in which:

FIG. 1 includes a schematic diagram of a flow dampener in a respirator fit tester of the prior art.

FIG. 2A includes a schematic diagram of a respirator fit tester of the present disclosure.

FIG. 2B includes a schematic diagram of a respirator fit tester of the present disclosure.

FIG. 2C includes a schematic diagram of a piezoelectric pump useful in the respirator fit testers of the present disclosure.

FIGS. 3A and 3B include schematic diagrams of layouts of various components of a respirator fit tester of the present disclosure.

FIG. 4 illustrates a schematic diagram of an exemplary computing environment of the respirator fit testers of the present disclosure.

FIG. 5 includes a graph of sound testing of prior art respirator fit testers and a respirator fit tester of the present disclosure.

FIG. 6A includes a pressure fluctuation graph of a prior art diaphragm pump and a prior art pulsation dampener.

FIG. 6B includes a pressure fluctuation graph of a respirator fit tester of the present disclosure.

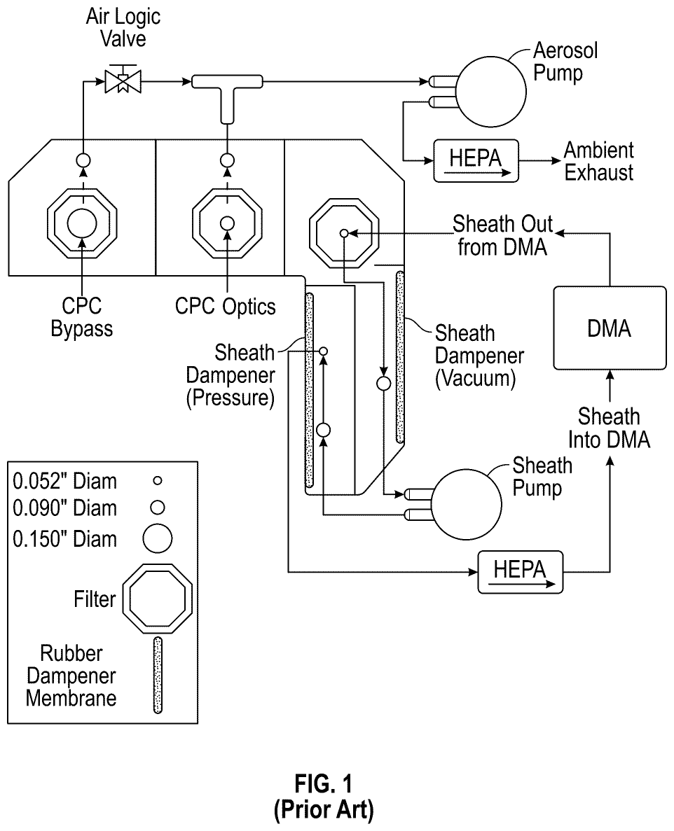

### DETAILED DESCRIPTION

The present disclosure relates to an improved respirator fit tester (“tester”) that includes one or more piezoelectric pumps configured to move aerosol from inside and outside of the mask of a respirator (“respirator” or “mask”) through a condensation particle counter. The piezoelectric pump(s) reduce noise and vibration of the tester and remove the need for flow dampeners. According to certain aspects, the tester may be configured to include a sheath air piezoelectric pump and a differential mobility analyzer (DMA).

Use of piezoelectric pumps in the disclosed testers may allow the ratio of a flow rate of the aerosol to a flow rate of the sheath air circulated in the DMA to be reduced. That is, in a standard prior art tester, the ratio of the aerosol flow rate to the sheath air flow rate is typically less than 0.2. However, the piezoelectric pumps of the presently disclosed system may support a ratio of the aerosol flow rate to the sheath air flow rate that is greater than 0.2, such as 0.25, or 0.33, or 0.4, or even 0.5. Moreover, the disclosed testers may be configured to work with both sealing respirators and non-sealing masks, e.g., N95. Further yet, the disclosed testers may be configured to automatically tailor the test configuration based on the mask type.

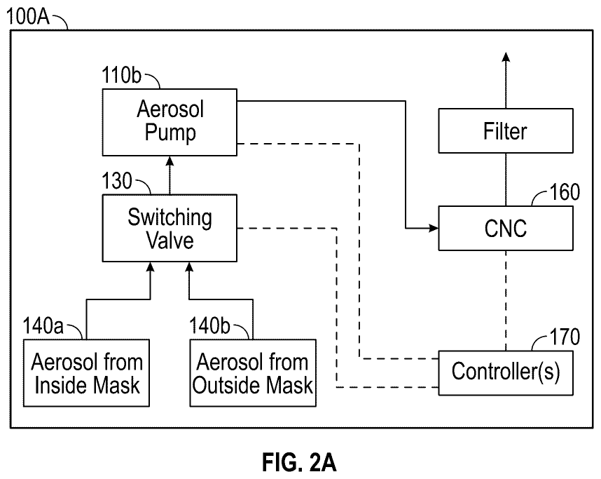

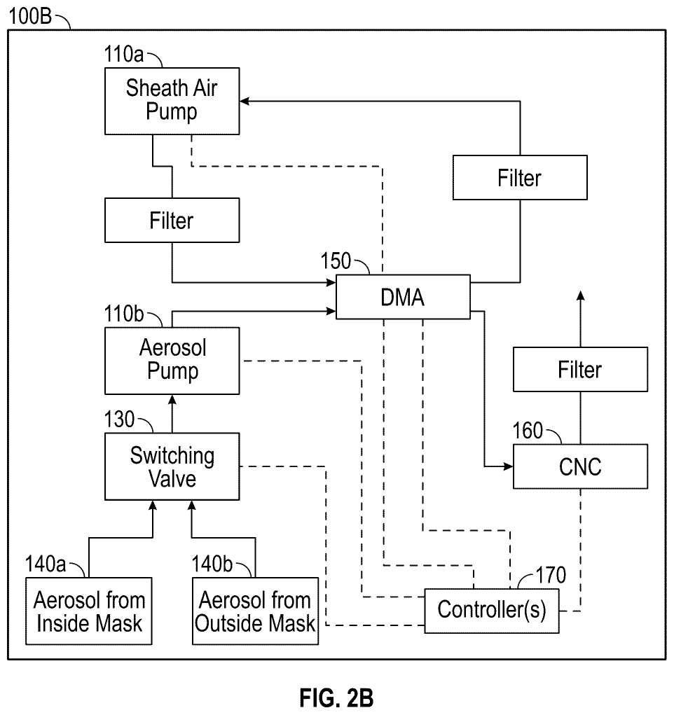

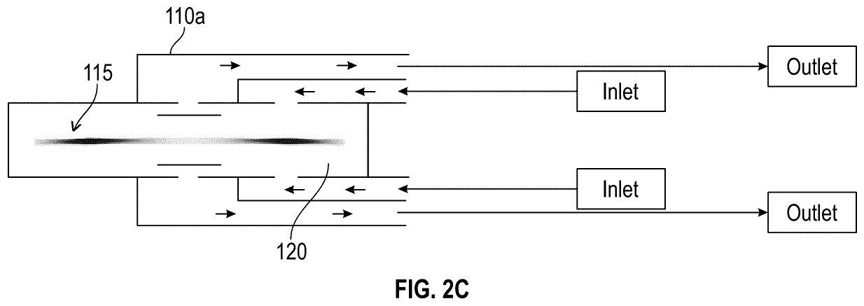

As illustrated schematically in FIG. 2A, the disclosed tester generally includes at least an aerosol piezoelectric pump (110b) and a condensation nuclei counter (CNC, 160). The aerosol piezoelectric pump pulls aerosol from either inside the mask 140a or outside the mask 140b into the CNC 160. A switching valve 130 controls selection of the aerosol from inside the mask or outside the mask.

As illustrated schematically in FIG. 2B, the disclosed tester may be configured to include a sheath air piezoelectric pump (also referred to as ‘first piezoelectric pump 110a) and an aerosol piezoelectric pump (also referred to as ‘second piezoelectric pump 110b), a differential mobility analyzer (DMA, 150), and a condensation nuclei counter (CNC, 160). The first piezoelectric pump 110a circulates sheath air through the DMA 150, while the second piezoelectric pump 110b pulls aerosol from either inside the mask 140a or outside the mask 140b through the DMA 150. A switching valve 130 controls selection of the aerosol from inside the mask or outside the mask. The second piezoelectric pump 110b then circulates a size-selected portion of the aerosol from the DMA 150 through the CNC 160.

As used in this application, the term “aerosol” refers to a suspension of elements (e.g., solid particles or liquid droplets) in a gaseous medium. Atmospheric or ambient air is an example of an aerosol, with air as the gaseous medium supporting the solid particles and liquid droplets. The particles found in ambient air vary widely in size across a range of about 30 nm to about 750 nm. Typically, 100 nm to 300 nm particles are the most likely to penetrate N95 respirators while 35 nm to 45 nm are excluded from these masks with excellent efficiency, i.e., about 99.9% excluded. Thus, testing aerosol for particles in this lower size range, i.e., particles having diameters of 35 nm to 45 nm, such as nominally 40 nm, provides an indication of leakage of ambient aerosol into the mask.

As mentioned, when included, the second piezoelectric pump 110b circulates aerosol from either inside the mask 140a or outside the mask 140b through the DMA 150. The DMA 150 is used to select a narrow range of particle sizes in each of the aerosol samples, typically particles having a diameter of 30 nm to 50 nm, including, but not limited to, 35 nm to 45 nm, or even 40 nm. These particles are too small to be quantified directly by optical detection. As such, the small particles in the size selected portion of the aerosol streams are grown to a larger size in a growth column of the CNC. The growth column comprises a saturator that heats a liquid-soaked wick to generate vapor, which passes to the condenser where it condenses onto the particles, thereby enlarging them. As the particles pass through the growth column, they are then detected by photometric light scattering. Thus, the CNC 160 measures particle concentration in the size-selected portion of the aerosol samples, i.e., the samples from inside the mask and the samples from outside the mask that have passed through the DMA. A ratio of the particle concentrations measured for each of these samples determines a fit factor. More specifically, the fit factor is a ratio of particle concentration outside a mask to particle concentration inside a mask, wherein an overall fit factor measured during a typical fit test is the harmonic mean of several such individual fit factors measured during a series of 15 second to 1-minute-long exercises (facial movements and body exercises).

The DMA 150 provides selection of particles having a specific size based on the flow rate of aerosol and sheath air and the electric field generated between opposing plates within the device. Particles of a certain electrical mobility (i.e., the velocity of a particle with a charge in an electric field of unit strength) are drawn to one of the electrified plates or swept downstream. The mobility of the particles within the DMA thus dictates the size selection of the particles. The ratio of aerosol flow rate to sheath air flow rate is thus an important determinant of the sensitivity and accuracy of a CNC respirator fit testing device.

Switching of the selection of aerosol from inside or outside the mask is generally controlled by the switching valve 130 based on signals sent from the control unit 170, which is in electronic communication with the first and second piezoelectric pumps (110a, 110b), the DMA 150, the CNC 160, and the switching valve 130 (e.g., via circuit boards of each, also referred to as processors). For example, the control unit(s) 170 may receive signals from the CNC 160 indicative of a particle count in a sample and may output control signals to the switching valve 130 and each of the first and second piezoelectric pumps (110a, 110b) to control the aerosol and sheath air flow rates based on user selected or automatically detected respirator characteristics and test requirements. The control unit(s) 170 may further analyze the signals received from the CNC 160 to provide an evaluation of leakage from the mask (i.e., “fit factor”) and other output related to performance of the tester and its various components.

The control unit 170 may be provided in any suitable form or combination of forms, e.g., a hardwired control device and/or a data processing system that includes a processor, one or more display devices, one or more input devices, and one or more data storage devices. In some instances, the control unit may include a combination of one or more hardwired control devices and one or more data processing systems. The control unit may further provide control of the tester to perform an automated fit test of the respirator. As will be discussed in more detail below, the disclosed tester may be part of a system comprising software configured to run on the control unit 170 and on one or more external computing devices, such as client or cloud computing devices.

Conventional CNC respirator fit testing devices exhibit an audible noise during the respirator fit test, as the fit testing device must pump aerosol from inside and outside the mask through the DMA to the CNC to measure the particle concentrations in each aerosol sample. The audible noise may be disruptive for a user, proctor, and/or industrial hygienist. As a non-limiting example, an industrial hygienist may run multiple instruments in the same room simultaneously, and the audible noise generated by each conventional fit testing device may be uncomfortable and may negatively impact results.

Moreover, conventional CNC respirator fit testing devices use positive displacement pumps such as diaphragm or rotary vane pumps, which provide a pulsed flow of the sheath air and aerosol. Pulsation dampeners have been utilized in these devices in an attempt to reduce the pressure fluctuations that these pumps generate. However, conventional pulsation dampeners are bulky and/or are prone to leak, thus reducing accuracy of the testing method.

The presently disclosed technology addresses one or more of these shortcomings by including two or more piezoelectric pumps that reduce or eliminate the audible noise and pressure fluctuations or “pulses.” With reference to FIG. 2C, the piezoelectric pumps (110a, 110b) of the presently disclosed testers use positive and negative voltage fluctuations to generate a high amplitude, high frequency acoustic standing wave 115 within an acoustic cavity 120, which in turn generates a pressure or a vacuum. This pressure wave creates areas of compression and rarefaction, wherein the pressure at the center of the wave drives the motion of a valve flap. The valve flap in an open position allows air flow, while the valve flap in a closed position blocks air flow. Increases in power to the piezoelectric pump cause an increase in flow rate. Thus, unlike conventional fit testers, the piezoelectric pumps of the presently disclosed tester do not rely on pulsed bulk compression of air within a cavity. Instead, the piezoelectric pumps provide a mechanism that reduces or eliminates noisy output and reduces or substantially eliminates pressure fluctuations.

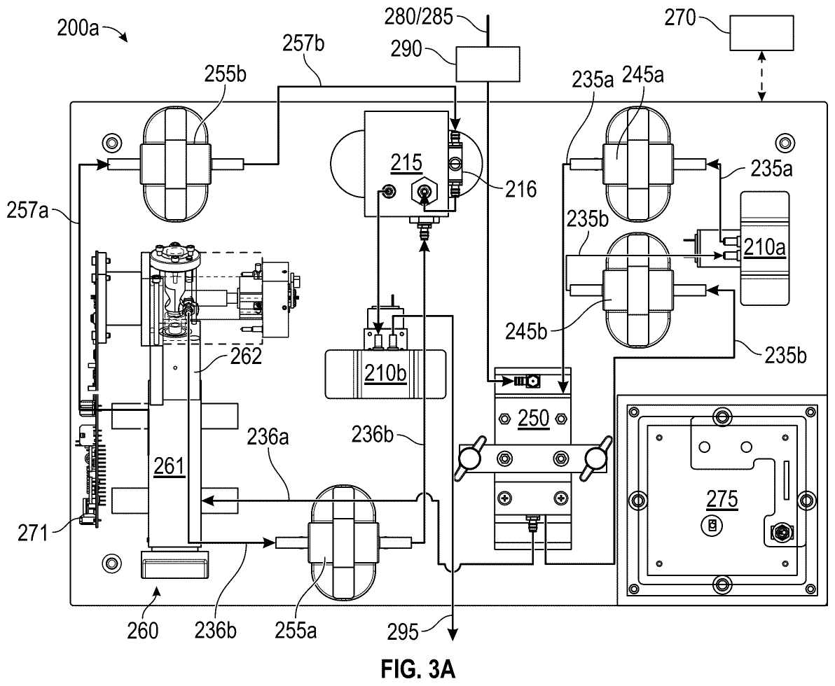

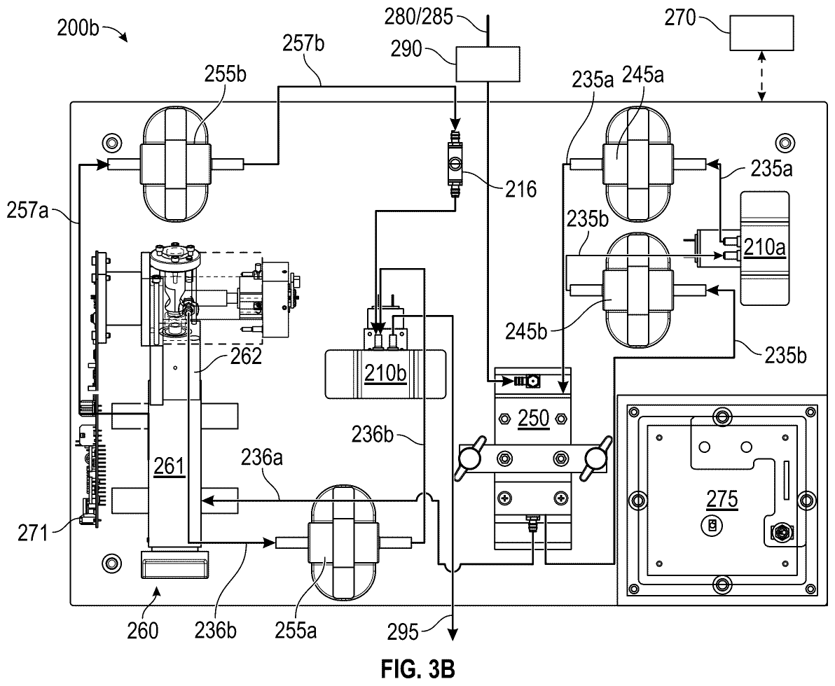

With reference to FIG. 3A, a tester 200a according to the present disclosure is illustrated schematically. The tester 200a includes at least a first piezoelectric pump 210a that is configured to circulate sheath air to a first filter 245a and onto the DMA 250, such as via conduits 235a. The sheath air exiting the DMA 250 is then circulated through a second filter 245b and back to the first piezoelectric pump 210a, such as via conduits 235b. Each of the first and second filters (245a, 245b) may be HEPA filters configured to remove a substantial portion of the particles from the air. However, while filters 245a and 245b are disclosed as HEPA filters, other filters are possible and within the scope of the present disclosure. Moreover, the conduits are typically flexible tubing or hose constructed of a suitable polymer. Moreover, while two filters (245a, 245b) are shown in FIG. 3A, fewer or more may be included.

According to certain configurations, the first piezoelectric pump 210a may comprise two or more individual piezoelectric pumps positioned in parallel to provide a sufficient sheath air flow rate.

The second piezoelectric pump 210b pulls aerosol from either inside the mask 280 or outside the mask 285 and circulates the sampled aerosol to the DMA 250. A size selected portion of the aerosol is then passed to the CNC 260 via conduit 236a where particles are detected via light scattering. The aerosol is then passed from the CNC 260 through a third filter 255a and a pulse dampener 215 via conduit 236b. A flow rate of the aerosol through the CNC 260 can be controlled by exiting a portion of the aerosol to a bypass conduit 257a, which connects to a fourth filter 255b and is passed to a bypass valve 216 via conduit 257b and into the pulse dampener 215. The bypass valve 216 may be controlled manually or via an actuator that is controlled by signals sent from the controller 270.

The flow from the pulse dampener 215, which now includes aerosol flow from the CNC 260 and aerosol flow sent through the bypass valve 216, is pulled through the second piezoelectric pump 210b and exhausted to ambient atmosphere (295). Of note, all aerosol from inside and outside the mask is filtered through either filter 255a or 255b prior to exhausting to ambient atmosphere. Filters 255a and 255b may be HEPA filters configured to remove exhausted particles (e.g., any potential biologic or other particles exhaled from the subject wearing the mask). However, while filters 255a and 255b are disclosed as HEPA filters, other filters are possible and within the scope of the present disclosure. Moreover, while two filters are shown in FIGS. 3A and 3B, fewer or more may be included. The conduits are typically flexible tubing or hose constructed of a suitable polymer.

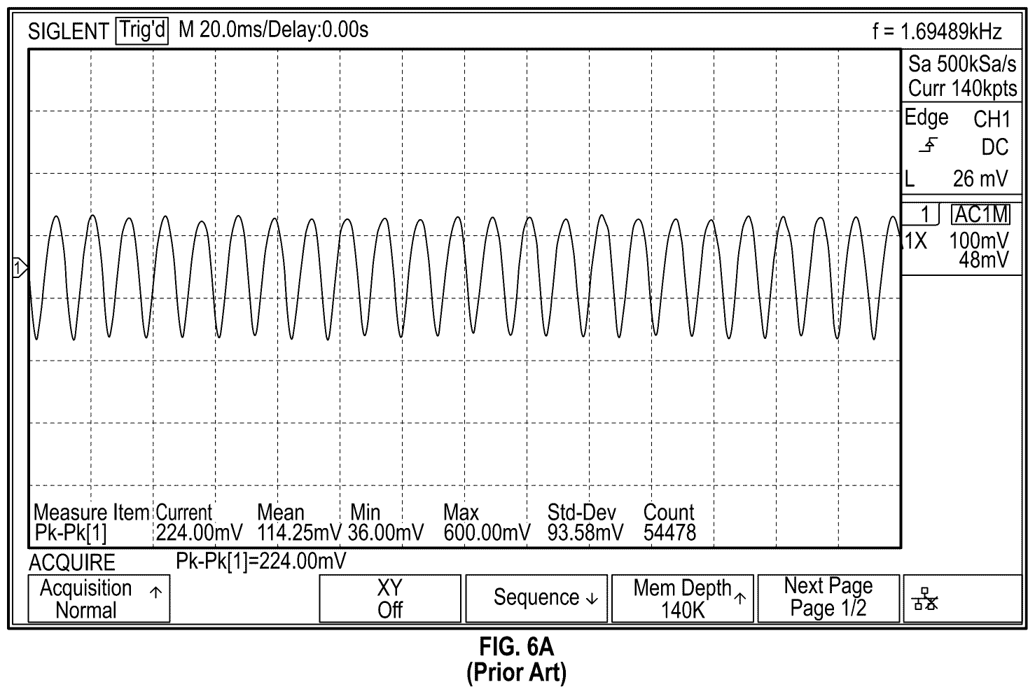

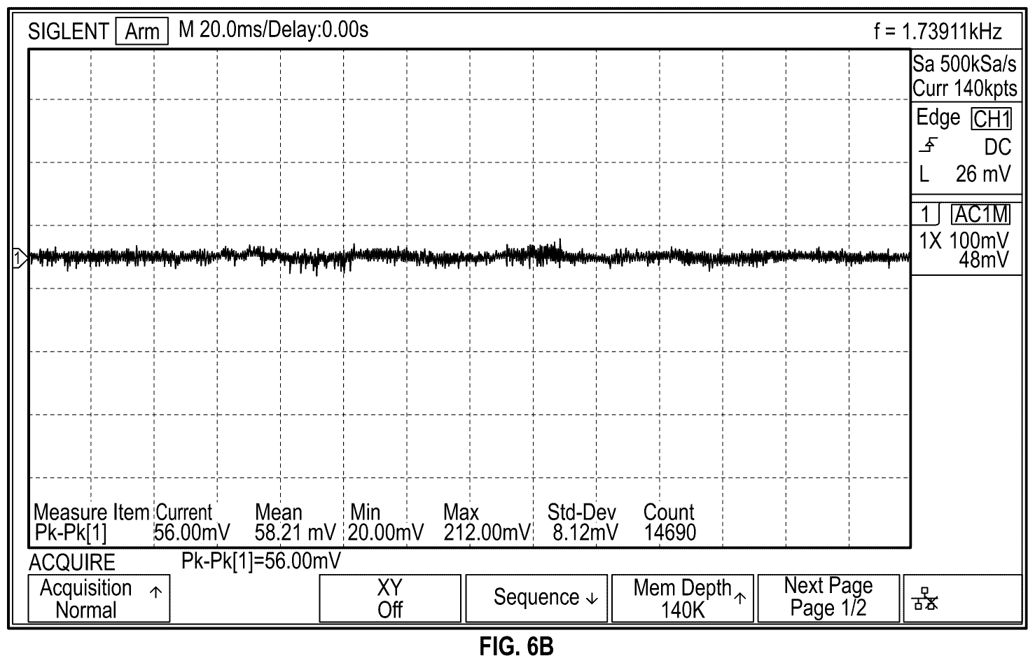

Use of the disclosed piezoelectric pumps (210a, 210b) in the disclosed testers eliminates the need for a pulse dampener (see FIGS. 6A and 6B). As such, according to certain aspects, the tester 200b may be absent a pulse dampener (e.g., 215), such as shown in FIG. 3B. In this configuration, the aerosol is pulled from the CNC 260 through the third filter 255a and out to exhaust 295 via the second piezoelectric pump 210b. The portion of the aerosol sent to the bypass conduit 257a is pulled through the fourth filter 255b and a bypass valve 216 via conduit 257b and out to exhaust 295 via the second piezoelectric pump 210b. The aerosol flow stream exiting the CNC 260 via conduit 236b and the portion of the aerosol sent to the bypass conduit (257a, 257b) may be combined before entry to the second piezoelectric pump 210b, such as via a ‘Y’ or ‘T’ connector.

Many prior art respirator fit testers include an additional pulse dampener to smooth air pulses within the sheath air flow stream. The piezoelectric pumps (210a, 210b) in the disclosed tester would also eliminate the need for such an additional pulse dampener.

A signal indicative of the concentration of particles in the sample is sent from the CNC 260 to a control unit 270 (see also FIGS. 2A and 2B). The control unit is configured to generate a fit factor corresponding to a quantitative effectiveness of the mask fitting a user based on these signals from the CNC 260. That is, the control unit 270 may be configured to receive a sample signal indicative of the particles counted in the size selected portion of the aerosol from inside the mask and a control signal indicative of the size selected portion of the aerosol from outside the mask and generate an output corresponding to a ratio of the control signal to the sample signal. The fit factor thus comprises a ratio of the concentration of particles in the aerosol from outside the mask to the signal to the concentration of particles in the aerosol from inside the mask.

The CNC 260 includes an inlet port, a growth column, and an optical element for counting particles. The growth column typically includes a saturation chamber 261 comprising a fluid-soaked wick that is heated to provide a vapor, such as a vapor of condensation fluid, through which the size selected particles from the DMA 250 travel. Exemplary condensation fluids include, but are not limited to, alcohol, such as isopropyl alcohol, water, or mixtures thereof. Downstream from the inlet port the growth column further comprises a condensation chamber 262 in which the temperature is reduced to provide vapor condensation on the size selected particles in the aerosol samples.

As noted above, the second piezoelectric pump 210b is configured to sample aerosol from inside and outside the mask. The sampling rate and duration may be controlled by a switching valve 290 configured to facilitate the alternating sampling of the aerosol from either inside the mask or outside the mask. The control unit 270, which may include a processor and a memory, is generally configured to send signals that control actuation of the switching valve 290.

Power may be provided to the various components (e.g., pumps, CNC, DMA, switching valve, etc.) and to the controller via standard cables and electrical circuitry. In some configurations, the DMA 250 may acquire power from a high voltage power supply 275 within the tester, which is supplied via the standard cables providing power to the system. The device may receive power from a standard wall outlet or may be powered by a rechargeable battery integrated into the device, wherein the battery may include a connector allowing power for recharging functions to be provided from a standard wall outlet.

The tester may be part of a system comprising a server having a server memory and a server processor. The server memory typically stores system software that is executable to provide user interaction with the tester and analysis of the various signals from the tester, such as from the control unit(s) 270, which may be a single control unit in electronic communication with each of the components of the tester. In some configurations, the control unit 270 may be part of the tester and may be in electronic communication with circuit boards that control each of the piezoelectric pumps (210a, 210b), the CNC 260, the DMA 250, the switching valve 290, and optionally the bypass valve 216. In some configurations, the bypass valve 216 may be manually adjusted. As example, the CNC 260 may be controlled by circuit board(s) (e.g., 271) that control the laser and collection of pulses related to real time counting of particles. As a further example, each of the piezoelectric pumps (210a, 210b) may be independently controlled by individual circuit boards or may be configured to be controlled by one circuit board.

The software may allow the user to input a respirator type, such as selection of a sealing or non-sealing respirator, or entry of a specific respirator make and model wherein the system determines the respirator type. Such user interaction may be enabled via a keyboard, a touch screen, voice control, and the like. Based on the user input, the system may enable or disable the differential mobility analyzer, wherein the DMA is enabled for non-sealing respirators and disabled for sealing respirators.

The system may further provide specific instructions to guide the user through setup of the tester, such as information on proper setup of the fit testing device, proper connection of the respirator (mask) to the fit testing device, etc. The system may further yet instruct the user to don the mask and to begin a respirator fit test. Signals indicative of particle concentrations in the various samples may be analyzed at the control unit 270 and/or by a processor of the server. Moreover, data calculated based on the detected signals may be reported to the user in real time, stored in a database for later review and comparison to historic values, and/or reported to a third party.

To provide for interactions with a user, one or more aspects of the disclosure may be implemented by specialized software algorithms. Exemplary algorithms and methods for performing a respirator fit test, and use of a virtual operator are disclosed in U.S. Pat. No. 12,023,529 and U.S. Patent Application Publication No. 2024/0390710, the entire contents of which are incorporated herein by reference. Each discloses methods to efficiently detect and troubleshoot failures in respirator fitting processes either with or without the need for a human proctor. Further, each discloses specialized software algorithms and methods for detecting failures in respirator fitting processes that are undetectable and not addressable by a human proctor.

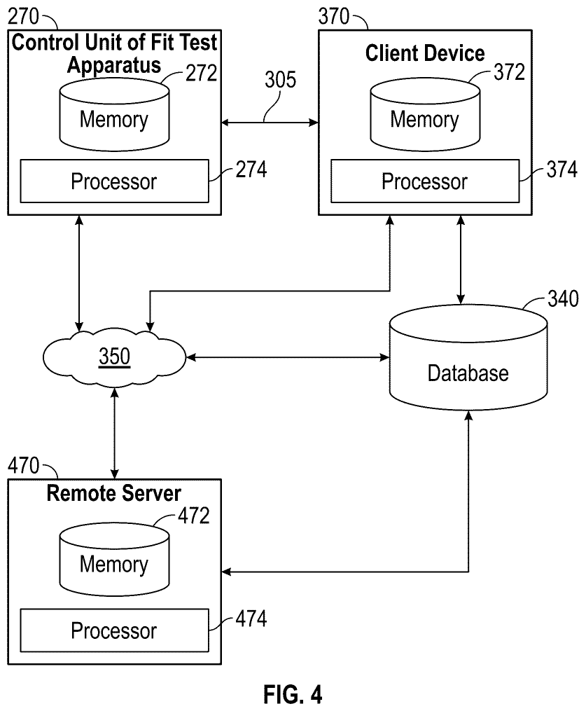

FIG. 4 illustrates a generalized example of a suitable computing environment (270, 370) in which the described methods and systems can be implemented. For example, all the computer-implemented functions described herein can be implemented by specialized software algorithms stored on a memory 272 of the control unit 270 and executed by a processor 274 thereof. Alternatively, only basic functions may be implemented by specialized software algorithms executed by the control unit 270, such as basic functionality, e.g., start/stop functions, pump flow rates, receiving signals from the CNC, etc. In either case, the tester may be part of a system comprising specialized software executable on a client device 370 having at least a memory 372 and a processor 374. Communication between the control unit 270 and the client device 370 may be via the cloud 350 or a local area network or direct hardwired connection (305). As such, the tester (100A, 100B, 200a, 200b) may include a network connection enabling wired or wireless connection to the client device 370 and/or to a remote server 470.

The client device 370 may be a client computing environment comprising specialized software algorithms that are installed locally, such as stored on local client memory 372 of the client device 370, and executed on a client processor 374 using the instructions stored on the client memory 372. Alternatively, or additionally, the computing environment may be a remote server computing environment 470 (computing cloud) wherein computer-implemented functions are executed on a server processor 474 using instructions stored on a server memory 472. A user may access the remote server computing environment 470 from their client device 370 and/or from a user panel on the tester, such as by a connection between the control unit 270 and the remote server 470 via the cloud 350.

Data related to fit test results, fit test parameters for various respirators, personnel or respirator specific data (e.g., historic mask fit test results, last test date for a mask or specific worker, etc.) may be stored locally on a memory 372 of the client device 370, remotely on a memory 472 of the remote server 470, and/or on a centralized database 340.

The computing environment is not intended to suggest any limitation as to scope of use or functionality of the technology, as the technology can be implemented in diverse general-purpose or special-purpose computing environments. For example, the disclosed technology can be implemented with other computer system configurations, including handheld devices, multiprocessor systems, microprocessor-based or programmable consumer electronics, network PCs, minicomputers, mainframe computers, and the like. The disclosed technology can also be practiced in distributed computing environments where tasks can be performed by remote processing devices (470) that can be linked through a communications network (350). In a distributed computing environment, program modules can be located in both local memory (272) and remote memory (372, 472).

### Definitions

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in a context of a relevant art and should not be interpreted in an idealized or overly formal sense unless expressly so defined herein.

As used herein, the term “sheath air” refers to a clean, filtered air stream that surrounds the aerosol that is being tested. This sheath air helps to prevent contamination of the aerosol by isolating it from external environmental factors. It ensures that the measurements taken are accurate and not influenced by any external particles or gases.

As used herein, the term “Condensation Nuclei Counting” or “condensation nuclei counter” or “CNC” refers to a quantitative fit testing method utilizing laser technology to measure aerosol leakage into a mask with aerosols in the ambient air as the test challenge agent. CNC may comprise a probe on the mask capable of sampling the air from inside the mask. Test challenging agents include but are not limited to ambient airborne particles.

As used herein, the term “fit factor” refers to a calculation based on a measurement of leakage of a mask made by an instrument during a series of exercises as part of an approved respirator fit test protocol. A “fit factor” may also refer to a quantitative estimate of the fit of a particular mask to a specific individual. For CNC, a “fit factor” estimates the ratio of the concentration of particles in ambient air to its concentration inside the mask when worn. CNC may calculate a “fit factor” by sampling the ambient aerosol concentration outside the mask and the concentration inside the mask, wherein the calculated fit factor is the concentration of the particles outside the mask divided by the particle concentration inside the mask. CNC may average the exercise fit factors using a harmonic mean to calculate an overall fit factor. A higher value fit factor may indicate a better fit and may be more appropriate for more vigorous work conditions.

As used herein, the term “respirator” or “mask” are used interchangeable and refer to, but are not limited to, a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, or a combination respirator.

In this description and in the appended claims, use of the singular forms “a,” “an,” and “the” includes the plural and plural encompasses singular, unless specifically stated otherwise. For example, although reference is made herein to “a” pump, or “the” respirator, one or more of any of these components and/or any other components described herein may be used.

Likewise, as used herein, a term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

In addition, features described with respect to certain example aspects may be combined in or with various other example aspects in any permutational or combinatory manner. Different aspects or elements of example aspects, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments may be described and illustrated with reference to one or more exemplary implementations. As used herein, the term “exemplary” means “serving as an example, instance, or illustration,” and should not necessarily be construed as preferred or advantageous over other variations of the tester, methods, and various embodiments thereof disclosed herein. “Optional” or “optionally” means that the subsequently described event or circumstance may or may not occur, and that the description includes instances where the implementation occurs and instances where it does not.

As used herein, the term “aspect” may be understood to mean a particular part or feature of the disclosed respirator fit tester or methods of making or using the disclosed respirator fit tester, wherein the present disclosure relates to any combination of the disclosed aspects.

The word “comprising” and forms of the word “comprising,” as used in this description and in the claims, does not limit the present disclosure to exclude any variants or additions. Additionally, although the present disclosure has been described in terms of “comprising,” the tester, methods, and various embodiments thereof detailed herein may also be described as consisting essentially of or consisting of. For example, while certain aspects of the present disclosure have been described in terms of a tester comprising a first and second micropump and a differential mobility analyzer, a tester “consisting essentially of” or “consisting of” these components is also within the present scope. In this context, “consisting essentially of” means that any additional components will not materially affect the efficacy of the tester or method(s) of use thereof.

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example aspects may be combined and sub-combined in and/or with various other example aspects. Also, different aspects and/or elements of example aspects, as disclosed herein, may be combined and sub-combined in a similar manner as well. Further, some example aspects, whether individually and/or collectively, may be components of a larger system, wherein other procedures may take precedence over and/or otherwise modify their application. Additionally, a number of steps may be required before, after, and/or concurrently with example aspects, as disclosed herein. Note that any and/or all methods and/or processes, at least as disclosed herein, may be at least partially performed via at least one entity or actor in any manner.

Notwithstanding that the numerical ranges and parameters setting forth the broad scope of the present disclosure are approximations and reported as precisely as possible, any numerical value inherently contains certain errors necessarily resulting from the standard variation found in their respective testing measurements. When ranges are given, any endpoints of those ranges and/or numbers within those ranges can be combined within the scope of the present disclosure.

Aspects of the present disclosure may be described herein with reference to flowchart illustrations and/or block diagrams of methods, testers (systems), and computer program products according to aspects of the disclosure. It will be understood that each block of the flowchart illustrations and/or block diagrams, and combinations of blocks in the flowchart illustrations and/or block diagrams, may be implemented by computer readable program instructions. The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

Words such as “then,” “next,” etc., are not intended to limit the order of the steps; these words may be simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

In the following description, certain details are set forth in order to provide a better understanding of various aspects of the methods disclosed herein. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

While particular aspects have been illustrated and described, it would be obvious to those skilled in the art that various other changes and modifications may be made without departing from the spirit and scope of the present disclosure. Those skilled in the art will recognize or be able to ascertain using no more than routine experimentation, numerous equivalents to the specific testers and methods described herein, including alternatives, variants, additions, deletions, modifications, and substitutions. This application, including the appended aspects, is therefore intended to cover all such changes and modifications that are within the scope of this application.

### Aspects

The present disclosure provides a respirator fit tester (“tester”) comprising a condensation nuclei counter, an aerosol piezoelectric pump configured to alternately circulate an aerosol from either inside a mask of a respirator or outside the mask of the respirator at a constant aerosol flow rate through the condensation nuclei counter, a switching valve configured to facilitate the alternating circulation of the aerosol from either inside the respirator or outside the respirator, and a control unit having a memory and a processor in electronic communication with the condensation nuclei counter.

The tester may provide a ratio of the aerosol flow rate to the sheath air flow rate may be 0.2 to 0.5, or 0.3 to 0.5, or 0.4 to 0.5.

The tester may be absent a flow dampener.

The first piezoelectric pump of the tester may comprise two or more individual piezoelectric pumps positioned in parallel.

The condensation particle counter generally includes an inlet port, a growth column, and an optical element for counting particles.

The condensation nuclei counter may comprise a wick in the growth column, wherein the wick is configured to provide vapor of a condensation fluid when heated, such as vapor of alcohol or water.

The condensation particle counter may be configured to provide a signal to the control unit corresponding to a quantity of particles counted.

The control unit may have a memory and a processor in electronic communication with the condensation nuclei counter and may be configured to receive the signal, wherein the signal comprises a sample signal indicative of the particles counted in the size selected portion of the aerosol from inside the respirator and a control signal indicative of the size selected portion of the aerosol from outside the respirator, and generate an output corresponding to a ratio of the control signal to the sample signal.

The control unit may continuously generate a real time ratio of the quantity of particles in the aerosol from outside the mask to the quantity of particles from inside the mask.

The control unit may provide signals to actuate the switching valve.

The tester may comprise a sheath air piezoelectric pump and a differential mobility analyzer, wherein the sheath air pump is configured to circulate sheath air through the differential mobility analyzer at a constant sheath air flow rate, and wherein the aerosol is circulated through the differential mobility analyzer before entering the condensation nuclei counter.

The tester may comprise a set of processors in electronic communication with each of the aerosol and sheath air piezoelectric pumps, the differential mobility analyzer, and the condensation nuclei counter, respectively.

The differential mobility analyzer may be configured to provide passage of a size selected portion of the aerosol, and wherein the control unit is configured to generate a fit factor corresponding to a quantitative effectiveness of the respirator fitting a user based on signals from the condensation nuclei counter for the size selected portion of the aerosol from inside the respirator and outside the respirator.

The tester may comprise a server having a server memory and a server processor, wherein the server memory stores computer-readable instructions that, when executed by the processor, cause the processor to: on a display device, query a user of the tester about a respirator type, and based on user input of the respirator type, enable or disable the differential mobility analyzer, wherein: if the respirator type is a non-sealing mask, the differential mobility analyzer is enabled, and if the respirator type is a sealing mask, the differential mobility analyzer is disabled.

The present disclosure further provides a system comprising any of the respirator fit testers disclosed herein and software comprising computer readable instructions that, when executed by a processor, cause the processor to: on a display device, query a user of the tester about a respirator type, and based on user input of the respirator type, enable or disable the differential mobility analyzer, wherein: if the respirator type is a non-sealing mask, the differential mobility analyzer is enabled, and if the respirator type is a sealing mask, the differential mobility analyzer is disabled.

The computer readable instructions of the system may further cause the processor to: on a display device, instruct the user to connect at least one tubing to the respirator and an inlet port on the tester, instruct the user to don the respirator, prompt the user to begin a respirator fit test, detect a signal from the condensation nuclei counter corresponding to particles counted, and analyze data of the respirator fit test on the processor.

The processor of the system may be a processor of a control unit of the respirator fit tester, a processor of an external client device, a processor of a could server, or any combination thereof.

### EXAMPLES

### Example 1: Sound Testing

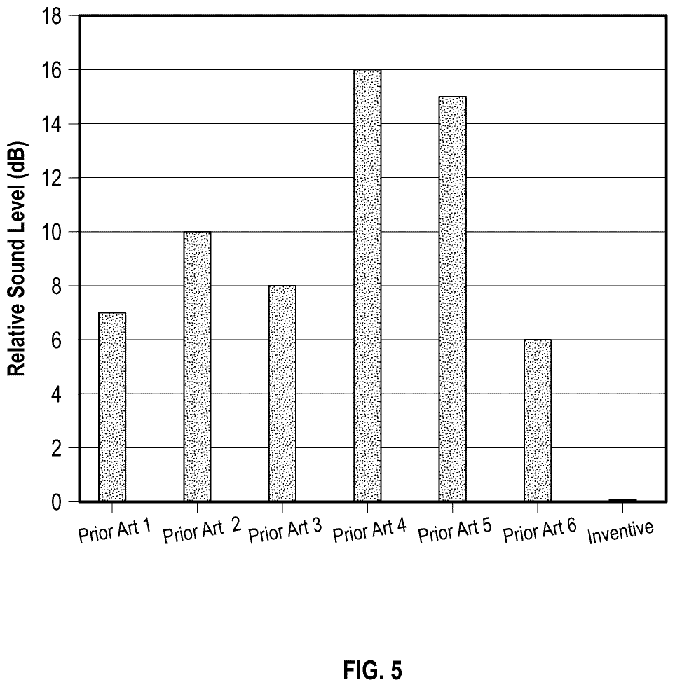

Sound levels of the piezoelectric pump of the presently disclosed respirator fit testers was measured and compared to sound levels from conventional respirator fit test devices comprising diaphragm pumps. With reference to FIG. 5, the sound output from (i) conventional respirator fit testers currently on the market (prior art 1, 2, and 3, testers comprising an aerosol diaphragm pump and a sheath diaphragm pump), and (ii) diaphragm pumps currently on the market (prior art 4-6; one or two diaphragm pumps), were compared to the sound output from the piezoelectric pump(s)s of the presently disclosed fit testers (inventive).

The sound output from the prior art systems comprising an aerosol diaphragm pump and a sheath diaphragm pump was found to range from just under 7 decibels (prior art tester 1) to 10 decibels (prior art tester 2). The sound output from a single aerosol diaphragm pump absent the housing was found to be 6 decibels (prior art pump 6), while the sound output from an aerosol diaphragm pump and a sheath diaphragm pump removed from the respirator testers, i.e., absent the housing, was found to be between 15 and 16 decibels (prior art testers 4 and 5). The increased sound output for the pumps absent the housing is likely due to the dampening effect the housing has on pump noise and vibration.

The presently disclosed tester (“inventive”) was found to output a sound level of 0 decibels, whether testing a single piezoelectric pump (e.g., aerosol pump) or two piezoelectric pumps (e.g., aerosol and sheath pumps). Thus, the respirator fit tester disclosed herein was found to be substantially or totally silent due to the inclusion of the piezoelectric pumps.

On note, in a standard test situation, more than one respirator fit tester may be used at one time. Thus, the sound output from each tester would be cumulative, ultimately representing substantial noise pollution in the typically confined areas in which testing is performed.

### Example 2: Pressure Testing

Pressure fluctuation testing was performed using a diaphragm pump and a pulsation dampener (FIG. 6A) such as found in the prior art testers (e.g., prior art pump 6).

Pressure fluctuation testing was also performed using the piezoelectric pump of the present disclosure (FIG. 6B). Even without a pulsation dampener, the piezoelectric pump of the present disclosure exhibited a significant decrease in pressure fluctuation compared to the prior art diaphragm pump.

### Example 3: Improvements in Performance

The inclusion of the piezoelectric pumps on the respirator fit testers disclosed herein may provide improvements in the ratio of aerosol to sheath air flow rates. The piezoelectric pumps may further provide improvements in the variability of the registered fit factors, when compared to prior art respirator fit testers. The piezoelectric pumps may further improve the selectivity of the DMA to specific size particles. For example, a tandem DMA test may be used to demonstrate the sharpness of the upper and lower cutoff for particle size.

What is claimed is:

1. A respirator fit tester comprising:
a condensation nuclei counter having an inlet port, a growth column, and an optical element for counting particles;
an aerosol piezoelectric pump configured to alternately circulate an aerosol from either inside a respirator or outside the respirator at a constant aerosol flow rate through the condensation nuclei counter;
a switching valve configured to facilitate the alternating circulation of the aerosol from either inside the respirator or outside the respirator; and
a control unit having a memory and a processor in electronic communication with the condensation nuclei counter, wherein the condensation particle counter is configured to provide a signal to the control unit corresponding to a quantity of particles counted.

2. The tester of claim 1, wherein the tester is absent a flow dampener.

3. The tester of claim 1, further comprising:
a sheath air piezoelectric pump; and
a differential mobility analyzer,
wherein the sheath air pump is configured to circulate sheath air through the differential mobility analyzer at a constant sheath air flow rate, and
wherein the aerosol is circulated through the differential mobility analyzer before entering the condensation nuclei counter.

4. The tester of claim 3, wherein a ratio of the aerosol flow rate to the sheath air flow rate is 0.2 to 0.5, or wherein a ratio of the aerosol flow rate to the sheath air flow rate is 0.3 to 0.5.

5. The tester of claim 1, wherein the control unit continuously generates a real time ratio of the quantity of particles in the aerosol from outside the mask to the quantity of particles from inside the mask.

6. The tester of claim 3, comprising a set of processors in electronic communication with each of the aerosol and sheath air piezoelectric pumps, the differential mobility analyzer, and the condensation nuclei counter, respectively.

7. The tester of claim 1, wherein the control unit provides signals to actuate the switching valve.

8. The tester of claim 3, wherein the differential mobility analyzer is configured to provide passage of a size selected portion of the aerosol, and wherein the control unit is configured to generate a fit factor corresponding to a quantitative effectiveness of the respirator fitting a user based on signals from the condensation nuclei counter for the size selected portion of the aerosol from inside the respirator and outside the respirator.

9. The tester of claim 3, comprising a server having a server memory and a server processor, wherein the server memory stores computer-readable instructions that, when executed by the processor, cause the processor to:
on a display device, query a user of the tester about a respirator type, and
based on user input of the respirator type, enable or disable the differential mobility analyzer, wherein:
if the respirator type is a non-sealing mask, the differential mobility analyzer is enabled, and
if the respirator type is a sealing mask, the differential mobility analyzer is disabled.

10. A respirator fit tester comprising:
a first piezoelectric pump;
a second piezoelectric pump;
a differential mobility analyzer; and
a condensation nuclei counter,
wherein the first piezoelectric pump is configured to circulate sheath air through the differential mobility analyzer at a constant sheath air flow rate and the second piezoelectric pump is configured to alternately circulate an aerosol from either inside the respirator or outside the respirator to the differential mobility analyzer at a constant aerosol flow rate,
wherein a ratio of the aerosol flow rate to the sheath air flow rate is 0.2 to 0.5, and
wherein a size selected portion of the aerosol is passed from the differential mobility analyzer to the condensation nuclei counter.

11. The tester of claim 10, wherein the tester is absent a flow dampener.

12. The tester of claim 10, wherein the ratio of the aerosol flow rate to the sheath air flow rate is 0.3 to 0.5.

13. The tester of claim 10, wherein the first piezoelectric pump comprises two or more individual piezoelectric pumps positioned in parallel.

14. The tester of claim 10, wherein the condensation nuclei counter includes an inlet port, a growth column, and an optical element for counting particles and wherein the condensation particle counter is configured to provide a signal corresponding to a quantity of particles counted.

15. The tester of claim 14, wherein the condensation nuclei counter comprises a wick in the growth column, wherein the wick is configured to provide vapor of a condensation fluid when heated, wherein the condensation fluid is alcohol or water.

16. The tester of claim 14, comprising a control unit having a memory and a processor in electronic communication with the condensation nuclei counter and configured to receive the signal, wherein the signal comprises a sample signal indicative of the particles counted in the size selected portion of the aerosol from inside the respirator and a control signal indicative of the size selected portion of the aerosol from outside the respirator, and generate an output corresponding to a ratio of the control signal to the sample signal.

17. The tester of claim 10, further comprising:
a control unit having a memory and a processor in electronic communication with the condensation nuclei counter; and
a switching valve configured to facilitate the alternating sampling of the aerosol from either inside the respirator or outside the respirator, wherein the control unit provides signals to actuate the switching valve.

18. The tester of claim 17, wherein the control unit is configured to:
receive a sample signal indicative of the quantity of particles counted in the size selected portion of the aerosol from inside the respirator and a control signal indicative of the quantity of particles in the size selected portion of the aerosol from outside the respirator, and
generate an output corresponding to a ratio of the control signal to the sample signal.

19. The tester of claim 17, wherein the control unit is configured to generate a fit factor corresponding to a quantitative effectiveness of the respirator fitting a user based on signals from the condensation nuclei counter for the size selected portion of the aerosol from inside the respirator and outside the respirator.

20. The tester of claim 10, comprising a server having a server memory and a server processor, wherein the server memory stores computer-readable instructions that, when executed by the processor, cause the processor to:
on a display device, query a user of the tester about a respirator type, and
based on user input of the respirator type, enable or disable the differential mobility analyzer, wherein:
if the respirator type is a non-sealing mask, the differential mobility analyzer is enabled, and
if the respirator type is a sealing mask, the differential mobility analyzer is disabled.
